(19) United States
(12) Patent Application Publication
(10) Pub. No.: US 2021/0016940 A1
(43) Pub. Date: Jan. 21, 2021

(54) TEMPERATURE-BASED RELIEF MECHANISM FOR A CONTAINER

(71) Applicant: Halliburton Energy Services, Inc., Houston, TX (US)

(72) Inventors: Dale E. Jamison, Houston, TX (US); William Walter Shumway, Spring, TX (US)

(73) Assignee: Halliburton Energy Services, Inc., Houston, TX (US)

(21) Appl. No.: 16/512,827

(22) Filed: Jul. 16, 2019

(51) Int. Cl. B65D 51/16; B65D 45/30; F16K 17/38

(52) U.S. Cl. CPC B65D 51/1638; F16K 17/383; B65D 45/30

(57) ABSTRACT

A re-sealable vessel includes a body with an open end and a lid assembly. The lid assembly includes a cap with a seal sized to seal against the open end of the body and the cap is at least partially formed from a fusible metal with a melting point less than a threshold temperature comprising a boiling point or a temperature associated with a threshold vapor pressure of a liquid contained within the body, such that when a temperature of the fusible metal exceeds the melting point, the fusible metal melts, leaving an aperture through the cap.

### BACKGROUND

Many fluids are injected and/or extracted during wellbore operations. As part of testing these fluids, the fluids are contained in sealed vessels for testing purposes. In some tests, the sealed vessels are heated in ovens capable of heating the sealed vessels to temperatures exceeding the boiling point of the drilling fluid. The testing procedures are set such that the sealed vessels are not heated to temperatures that exceed the boiling point of the drilling fluid. However, in some instances the sealed vessels may be inadvertently allowed to heat up to temperatures exceeding the boiling point of the drilling fluid sealed within the vessel. In such instances, the drilling fluid begins to boil, thereby increasing the pressure within the sealed vessel. Without a mechanism to relieve the pressure, the pressure can build to an amount that exceeds the physical limits of the sealed vessel, thereby causing the vessel to rupture.

### BRIEF DESCRIPTION OF THE DRAWINGS

Embodiments of the temperature-based relief valve are described with reference to the following figures. The same numbers are used throughout the figures to reference like features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1 illustrates an exploded view of drilling fluid contained within a re-sealable vessel; and

FIGS. 2A-2C illustrate embodiments of a lid incorporating a fusible material.

### DETAILED DESCRIPTION

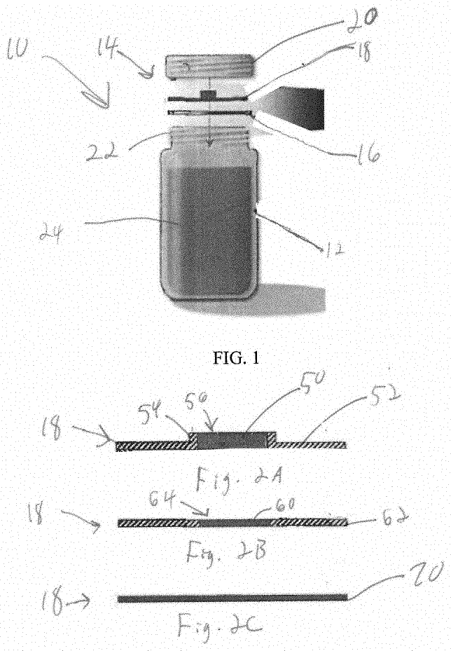

FIG. 1 is an exploded view of a re-sealable vessel 10, such as a jar, that includes a body 12 with a neck portion 22 and a lid assembly 14 that includes a seal 16, a cap 18, and an outer band 20. Further, the body 12 is hollow and open at the neck portion 22 to receive and contain a fluid 24. As an example, the body 12 may be composed of a clear material such as glass or polymer to enable the fluid 24 to be viewable from outside the body 12. Further, the vessel 10 is a container sized for testing fluids. For example, the vessel 10 may be capable of containing up to 5 gallons of fluid.

The lid assembly 14 couples to the neck portion 22 of the body 12 to enclose and fluidly seal the body 12. As an example, the body 12 includes a neck portion 22 that is threaded to interact with the matching threads on the outer band 20. The cap 18 is a solid circular member that fully covers the opening provided by the neck portion 22 when the cap 18 is placed over the neck portion 22. The seal 16 is a ring-shaped member that can fit between the cap 18 and the neck portion 22 and prevent the fluid 24 from escaping the body 12 when the seal is affected. The outer band 20 extends partially radially inward at an upper portion to serve as a ledge to hold the cap 18 in place, and apply a downward pressure on the seal 16 and the cap 18 as, in the example shown in FIG. 1, the outer band 20 is threaded onto the body 12 to secure the seal 16 and cap 18 to the body 12.

As described above, the seal 16, the cap 18, and the outer band 20 are all separate from one another. Alternatively, the seal 16, the cap 18, and the outer band 20 can be integral, the seal 16 and the cap 18 can be integral and separate from the outer band 20, or the cap 18 and the outer band 20 can be integral and separate from the seal 16. Additionally, other connection methods than threads may be used to connect the lid assembly 14 to the body 12. Further, the cap 18 is at least partially composed of a fusible metal that is chosen such that the pressure required to escape through the cap 18 is less than the pressure required to break through the body 12 when the temperature is at or above the boiling point of the fluid 24 or the vapor pressure is high enough to cause the cap 18 to break before the body 12 breaks. For example, the fusible metal may include a melting point that is lower than the boiling point of the fluid 24, thereby causing the fusible metal to melt away, leaving an aperture in its place when the temperature is at the boiling point of the fluid 24. For example, before the boiling point of the fluid 24 is reached, the vapor pressure produced by the fluid 24 rises as the temperature of the fluid 24 rises. The fusible metal may be chosen such that it melts or weakens sufficiently to break at a temperature associate with a threshold amount of vapor pressure exerted by the fluid 24 before the boiling point of the fluid 24 is reached.

The fluid 24 is contained within the vessel 10 to undergo testing to determine properties of the fluid 24. For example, the fluid 24 may be a drilling fluid undergoing temperature testing to determine how the drilling fluid reacts to downhole temperature conditions. In such a test, the drilling fluid is placed within the body 12 and the lid assembly 14 is threaded onto the body 12 to secure the drilling fluid within the vessel 10. Then, the vessel 10 is placed within a heating apparatus, such as an oven, to increase the temperature to a testing temperature.

The test is designed such that the testing temperature remains below a boiling point of the drilling fluid. However, in some instances, the testing temperature may inadvertently rise to or above the boiling point of the drilling fluid, thereby causing the drilling fluid to boil, and potentially increasing the pressure within the vessel 10. The increased testing temperature however also causes the fusible metal in the cap 18 to melt, thereby leaving an opening in the cap 18 for the gaseous drilling fluid to escape. Alternatively, the fusible metal weakens such that the yield strength of the cap 18 decreases below the yield strength of the body 12 such that pressure build-up from the gaseous drilling fluid breaks through the cap 18 before and rather than breaking through the body 12.

FIGS. 2A-2C illustrate different embodiments of the cap 18. In FIG. 2A, the cap 18 includes a fusible metal portion 50 and a non-fusible metal portion 52. The fusible metal portion 50 has a lower melting point than the non-fusible metal portion 52, and the melting point of the fusible metal portion is either lower than the boiling point of the fluid 24, or the melting point is low enough such that the yield strength of the fusible metal portion 50 decreases below the yield strength of the body 12 when the temperature is at or above the boiling point of the fluid 24. The non-fusible metal portion 52 is a disc that includes a raised lip 54 surrounding a centralized aperture 56. The fusible metal portion 50 fills the aperture 56 such that, if the fusible metal portion 50 melts away, the aperture 56 is open. In FIG. 2B, the cap 18 includes a non-fusible metal portion 62 including an aperture 64. Further, a fusible metal portion 60 fills the aperture 64 such that, if the fusible metal portion 60 melts away, the aperture 64 is open. Alternatively, the apertures 56, 64 may not be centralized and can be formed in any shape, at any location in the cap 18. Further, any number of apertures 56, 64 can be utilized, including 2, 3, 4, 5, 6, or more apertures 56, 64. Alternatively, the entirety of the cap 18 can be formed from a fusible metal 70, as illustrated in FIG. 2C.

As described above, a seal 16 separate from the cap 18 is provided to fluidly seal the vessel 10. Alternatively, the material properties of the cap 18 may allow the cap 18 to provide a sufficient seal against the body 12, and the seal 16 is omitted. For example, if the entirety of the cap 18 is composed of a fusible metal, the fusible metal may be soft enough to conform to the contours of the surface of the body 12 to provide a suitable seal.

Further, the fusible metal chosen may be selected from the following table:

TABLE 1

| Type/Melting | | | | | | |
|---|---|---|---|---|---|---|
| point in | | | | | | |
| degrees | % | % | % | % | % | % |
| Fahrenheit | Antimony | Bismuth | Cadmium | Lead | Tin | Indium |
| Roto 117 | 0 | 44.7 | 5.3 | 22.6 | 8.3 | 19.1 |
| Roto 136 | 0 | 49 | 0 | 18 | 12 | 21 |
| Roto 140 | 0 | 47.5 | 9.5 | 25.4 | 12.6 | 5 |
| Roto 144 | 0 | 32.5 | 0 | 0 | 16.5 | 51 |
| Roto 147 | 0 | 48 | 9.6 | 25.6 | 12.8 | 4 |
| Roto 158 | 0 | 50 | 10 | 26.7 | 13.3 | 0 |
| Roto 158-190 | 0 | 42.5 | 8.5 | 37.7 | 11.3 | 0 |
| Roto 174 | 0 | 57 | 0 | 0 | 17 | 26 |
| Roto 202 | 0 | 62.5 | 0 | 0 | 37.5 | 0 |
| Roto 203 | 0 | 52.5 | 0 | 32 | 15.5 | 0 |
| Roto 208 | 0 | 50 | 0 | 25 | 25 | 0 |
| Roto 212 | 0 | 39.4 | 0 | 29.8 | 30.8 | 0 |
| Roto 217-440 | 9 | 48 | 0 | 28.5 | 14.5 | 0 |
| Roto 255 | 0 | 55.5 | 0 | 44.5 | 0 | 0 |
| Roto 281 | 0 | 58 | 0 | 0 | 42 | 0 |
| Roto 281-338 | 0 | 40 | 0 | 0 | 60 | 0 |

As an example, the fluid 24 may be composed of mostly water, and thus has a boiling point near 212 degrees Fahrenheit. Accordingly, the fusible metals with a melting point below or near 212 degrees Fahrenheit are particularly useful as they will melt at a temperature lower than the boiling point of the typical fluid 24. Referencing Table 1, fusible metals with a melting point at or below 212 degrees Fahrenheit contain 0% Antimony, between 32.5% and 62.5% Bismuth, between 0% and 10% Cadmium, between 0% and 37.7% Lead, between 8.3% and 37.5% Tin, and between 0% and 51% Indium. Further, fusible metals with a melting point between 158 and 208 degrees Fahrenheit are chosen so that the testing temperature can increase to 150 degrees Fahrenheit without the fusible metal melting, while also providing a fusible metal that melts before the boiling point of water (i.e., 212 degrees Fahrenheit). In this manner, the fusible metal does not interfere with testing at normal testing temperatures, while also providing pressure relief when the temperature is too high. Referencing Table 1, fusible metals with a melting point between 158 and 208 degrees Fahrenheit contain 0% Antimony, between 42.5% and 62.5% Bismuth, between 0% and 10% Cadmium, between 0% and 37.7% Lead, between 11.3% and 37.5% Tin, and between 0% and 26% Indium. Thus, using these parameters, an example fusible metal may be one of Roto158, Roto 158-190, Roto 174, Roto 202, Roto 203, and Roto 208.

In addition, the fusible metal may be chemically isolated from the fluid 24 contained within the vessel 10. For example, a film may be coupled to an exterior portion of the fusible metal, particularly the exterior portion of the fusible metal that faces the interior of the vessel 10. The film may be composed of any chemically isolating material, such as glass, polymer, epoxy, polyurethane, polyethylene, Teflon, polypropylene, rubber, elastomer, or metal. Further, the film is designed to fail in conjunction with the thermally triggered release of pressure provided by the fusible metal.

Further examples may include:

Example 1 is a re-sealable vessel that includes a body with an open end and a lid assembly. The lid assembly includes a cap with a seal sized to seal against the open end of the body and the cap is at least partially formed from a fusible metal with a melting point less than a threshold temperature comprising a boiling point or a temperature associated with a threshold vapor pressure of a liquid contained within the body, such that when a temperature of the fusible metal exceeds the melting point, the fusible metal melts, leaving an aperture through the cap.

In Example 2, the subject matter of Example 1 can further include wherein the cap is entirely formed from the fusible metal.

In Example 3, the subject matter of Examples 1-2 can further include wherein the seal and the cap are separate from one another or the seal is integral to a portion of the cap.

In Example 4, the subject matter of Examples 1-3 can further include an outer band configured to couple to the body and secure the cap to the body when coupled to the body.

In Example 5, the subject matter of Examples 1-4 can further include wherein the melting point of the fusible metal is between 158 degrees Fahrenheit and 208 degrees Fahrenheit.

In Example 6, the subject matter of Examples 1-5 can further include wherein only a portion of the cap is formed from a non-fusible metal.

In Example 7, the subject matter of Example 6 can further include wherein the cap includes a second aperture formed through the non-fusible metal, and the fusible metal fills the second aperture, and wherein the aperture is formed within the second aperture.

In Example 8, the subject matter of Example 7 can further include wherein the cap comprises a lip surrounding the aperture.

In Example 9, the subject matter of Examples 1-8 can further include a film coupled to the fusible metal, and the film is configured to chemically isolate the fusible metal from the liquid within the body.

In Example 10, the subject matter of Examples 1-9 can further include wherein the fusible metal includes between 42.5% and 62.5% bismuth, between 0% and 10% cadmium, between 0% and 37.7% lead, between 11.3% and 37.5% tin, and between 0% and 26% indium.

Example 11 is a method for testing a fluid, that includes adding the fluid to a body of a vessel and sealing the vessel with a lid assembly, the lid assembly including a cap with a seal sized to seal against an open end of the jar body and the cap is at least partially formed from a fusible metal with a melting point less than a threshold temperature comprising a boiling point or a temperature associated with a threshold vapor pressure of a liquid contained within the body, such that when a temperature of the fusible metal exceeds the melting point, the fusible metal melts, leaving an aperture through the cap. The method further includes heating the sealed vessel such that the fusible metal melts, thereby leaving the aperture for the gaseous fluid to escape.

In Example 12, the subject matter of Example 11 can further include forming the entirety of the cap from the fusible metal.

In Example 13, the subject matter of Examples 11-12 can further include forming the seal and the cap separate from one another.

In Example 14, the subject matter of Examples 11-13 can further include wherein the melting point of the fusible metal is between 158 degrees Fahrenheit and 208 degrees Fahrenheit.

In Example 15, the subject matter of Examples 11-14 can further include wherein only a portion of the cap is formed from a non-fusible metal.

In Example 16, the subject matter of Example 15 can further include wherein the cap comprises a second aperture formed through the non-fusible metal, and the fusible metal fills the aperture.

In Example 17, the subject matter of Example 16 can further include wherein, upon melting, the fusible metal leaves the second aperture open.

In Example 18, the subject matter of Example 16 can further include wherein the cap includes a lip surrounding the aperture.

In Example 19, the subject matter of Examples 11-18 can further include chemically isolating the fusible metal from the fluid via a film coupled to the fusible metal.

In Example 20, the subject matter of Examples 11-19 can further include wherein the fusible metal includes between 42.5% and 62.5% bismuth, between 0% and 10% cadmium, between 0% and 37.7% lead, between 11.3% and 37.5% tin, and between 0% and 26% indium.

One or more specific embodiments of the system and method for the temperature-based relief valve have been described. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

Certain terms are used throughout the description and claims to refer to particular features or components. As one skilled in the art will appreciate, different persons may refer to the same feature or component by different names. This document does not intend to distinguish between components or features that differ in name but not function.

Reference throughout this specification to “one embodiment,” “an embodiment,” “embodiments,” “some embodiments,” “certain embodiments,” or similar language means that a particular feature, structure, or characteristic described in connection with the embodiment may be included in at least one embodiment of the present disclosure. Thus, these phrases or similar language throughout this specification may, but do not necessarily, all refer to the same embodiment.

The embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to suggest that the scope of the disclosure, including the claims, is limited to that embodiment.

What is claimed is:

1. A re-sealable vessel comprising:
a body with an open end; and
a lid assembly comprising a cap comprising a seal sized to seal against the open end of the body, wherein the cap at least partially comprises a fusible metal with a melting point less than a threshold temperature comprising a boiling point or a temperature associated with a threshold vapor pressure of a liquid contained within the body, such that when a temperature of the fusible metal exceeds the melting point, the fusible metal melts, leaving an aperture through the cap.

2. The re-sealable vessel of claim 1, wherein the cap is entirely formed from the fusible metal.

3. The re-sealable vessel of claim 1, wherein the seal and the cap are separate from one another or the seal is integral to a portion of the cap.

4. The re-sealable vessel of claim 1, further comprising an outer band configured to couple to the body and secure the cap to the body when coupled to the body.

5. The re-sealable vessel of claim 1, wherein the melting point of the fusible metal is between 158 degrees Fahrenheit and 208 degrees Fahrenheit.

6. The re-sealable vessel of claim 1, wherein only a portion of the cap is formed from a non-fusible metal.

7. The re-sealable vessel of claim 6, wherein the cap comprises a second aperture formed through the non-fusible metal, and the fusible metal fills the second aperture, and wherein the aperture is formed within the second aperture.

8. The re-sealable vessel of claim 7, wherein the cap comprises a lip surrounding the aperture.

9. The re-sealable vessel of claim 1, further comprising a film coupled to the fusible metal, and the film is configured to chemically isolate the fusible metal from the liquid within the body.

10. The re-sealable vessel of claim 1, wherein the fusible metal comprises:
between 42.5% and 62.5% bismuth;
between 0% and 10% cadmium;
between 0% and 37.7% lead;
between 11.3% and 37.5% tin; and
between 0% and 26% indium.

11. A method for testing a fluid, comprising:
adding the fluid to a body of a vessel;
sealing the vessel with a lid assembly comprising a cap comprising a seal sized to seal against an open end of the body and wherein the cap at least partially comprises a fusible metal with a melting point less than a threshold temperature comprising a boiling point or a temperature associated with a threshold vapor pressure of a liquid contained within the body, such that when a temperature of the fusible metal exceeds the melting point, the fusible metal melts, leaving an aperture through the cap; and
heating the sealed vessel such that the fusible metal melts, thereby leaving the aperture for the gaseous fluid to escape.

12. The method of claim 11, further comprising forming the entirety of the cap from the fusible metal.

13. The method of claim 11, further comprising forming the seal and the cap separate from one another.

14. The method of claim 11, wherein the melting point of the fusible metal is between 158 degrees Fahrenheit and 208 degrees Fahrenheit.

15. The method of claim 11, wherein only a portion of the cap is formed from a non-fusible metal.

16. The method of claim 15, wherein the cap comprises a second aperture formed through the non-fusible metal, and the fusible metal fills the aperture.

17. The method of claim 16, wherein, upon melting, the fusible metal leaves the second aperture open.

18. The method of claim 16, wherein the cap comprises a lip surrounding the aperture.

19. The method of claim 11, further comprising chemically isolating the fusible metal from the fluid via a film coupled to the fusible metal.

20. The method of claim 11, wherein the fusible metal comprises:
between 42.5% and 62.5% bismuth;
between 0% and 10% cadmium;
between 0% and 37.7% lead;
between 11.3% and 37.5% tin; and
between 0% and 26% indium.
